(19) United States
(12) Patent Application Publication
(10) Pub. No.: US 2005/0171740 A1
(43) Pub. Date: Aug. 4, 2005

(54) Synchronous multi-channel acquisition system for measuring physical parameters, acquisition module used and method implemented in such a system

(75) Inventor: Alain Pasty, Fontenay-Les-Briis (FR)

Correspondence Address: YOUNG & THOMPSON, 745 SOUTH 23RD STREET, 2ND FLOOR, ARLINGTON, VA, 22202, US

(73) Assignee: ERMME, F-91710 Vert Le Petit (FR)

(21) Appl. No.: 10/514,330

(22) PCT Filed: May 13, 2003
(86) PCT No.: PCT/FR03/01447

(30) Foreign Application Priority Data
May 15, 2002 (FR) 02/05947

(51) Int. Cl. G06F 11/00

(52) U.S. Cl. 702/188

(57) ABSTRACT

A multichannel acquisition system for measuring physical quantities includes a plurality of acquisition modules each constituting at least one acquisition channel. At least one of the acquisition modules includes synchronizing elements for transmitting a synchronizing signal to at least another acquisition module, in response to a synchronization instruction. The synchronizing signal can be optically transmitted, by magnetic coupling or by radio waves.

The present invention relates to a multi-channel acquisition system for measuring physical parameters. This system comprises a plurality of acquisition modules each constituting at least one acquisition channel. The present invention also relates to an acquisition module used in such a system and to a method implemented in this system.

The invention has a particularly useful application in the field of measuring physical parameters by the acquisition of analog electrical signals coming from a sensor or from any other measurement object. Acquisition modules generally have the function of converting analog signals into digital signals destined for a microcomputer or any other calculating and processing means.

By way of example, when an experiment necessitates numerous acquisition channels, it is possible to use a processing unit such as a microcomputer connected to several acquisition modules. Each acquisition module can comprise one or more acquisition channels. In general, the acquired signals are sent to a microcomputer which has the task of processing them.

The objective of the invention is a new multi-channel acquisition system in which the acquired signals are synchronized.

This objective is achieved with a multi-channel acquisition system for measuring physical parameters, comprising a plurality of acquisition modules each constituting at least one acquisition channel. According to the invention, at least one of the acquisition modules comprises synchronization means for transmitting a synchronization signal to at least one other synchronization module in response to a synchronization instruction.

With the system according to the invention, the acquisition modules can be synchronized starting from a given time. The synchronization signal can be equivalent to a start signal, a time t₀ which signifies the time origin of the acquired signals. This synchronization signal can have the effect of an authorization to transmit acquired signals to processing units or of activating acquisition modules which were previously in standby mode.

This system according to the invention can also allow the production of a group or cluster of several synchronized acquisition systems.

According to a first embodiment of the invention, the synchronization means can comprise means for transmitting an optical synchronization signal. Preferably, the acquisition modules are then interconnected by means of optical fibres. When optical fibres are not used, the acquisition modules can have an arrangement such that the optical receivers can pick up the signals coming from optical transmitters, i.e. an arrangement in which the acquisition modules are placed side by side.

According to another variant of the invention, the synchronization means can comprise means for transmitting a synchronization signal by magnetic coupling.

According to yet another variant of the invention, the synchronization means can comprise means for transmitting a synchronization signal by radio waves. In order to do this, it is possible to arrange antennas in the acquisition modules. In this way all positioning constraints, due for example to a physical connection between the modules in the case of optical fibres, are eliminated.

According to the invention, the synchronization instruction can come from an electrical signal acquired from a measurement object. This electrical signal is the analog signal at the input of an acquisition module, the instruction being for example generated when that analog signal exceeds a predetermined threshold.

Provision can be made for all of the acquisition modules to transmit digital signals to processing units only at the time when one of these acquisition modules detects, on its input, an analog signal whose amplitude exceeds a predetermined threshold. This is the synchronization signal which makes it possible to alert all of the acquisition modules.

The synchronization instruction can also come from a processing unit connected to the acquisition module transmitting the synchronization signal.

According to one embodiment of the invention, the acquisition modules are physically interconnected in a star configuration. It is also possible, however, for them to be physically interconnected in series, each acquisition module placed between two other modules having the capability both of receiving and of transmitting the synchronization signal.

According to another aspect of the invention, an acquisition module is provided for measuring physical parameters. This module comprises synchronization means for transmitting a synchronization signal to at least one other acquisition module, in response to a synchronisation instruction. This acquisition module can also comprise means for receiving a synchronization signal coming from at least one other acquisition module.

According to yet another aspect of the invention, an acquisition method is provided for measuring physical parameters. According to this method, when an acquisition module receives an instruction, that acquisition module transmits a synchronization signal to the other acquisition modules.

Moreover, with each acquisition module comprising an internal dating system, it is possible to associate the synchronization signal with a time logged in the internal dating system of each acquisition module. In other words, each acquisition module having internal dating, the synchronization signal makes it possible to define in each acquisition module a specific individual time t₀, marked off in the internal dating system of each acquisition module. Dating can consist of marking off any event in milliseconds, for example by means of an internal clock having a twenty four hour cycle and recording times in milliseconds. By way of example, in a first acquisition module, the synchronization signal can correspond to an internal time of 122 milliseconds, whilst in a second acquisition module the synchronization signal can correspond to an internal time of 130 milliseconds. It is the microcomputer arranged downstream that will reposition the signals coming from the different acquisition modules.

Other advantages and characteristics of the invention will appear on examining the detailed description of one embodiment, that is in no way limitative, and the appended drawing in which:

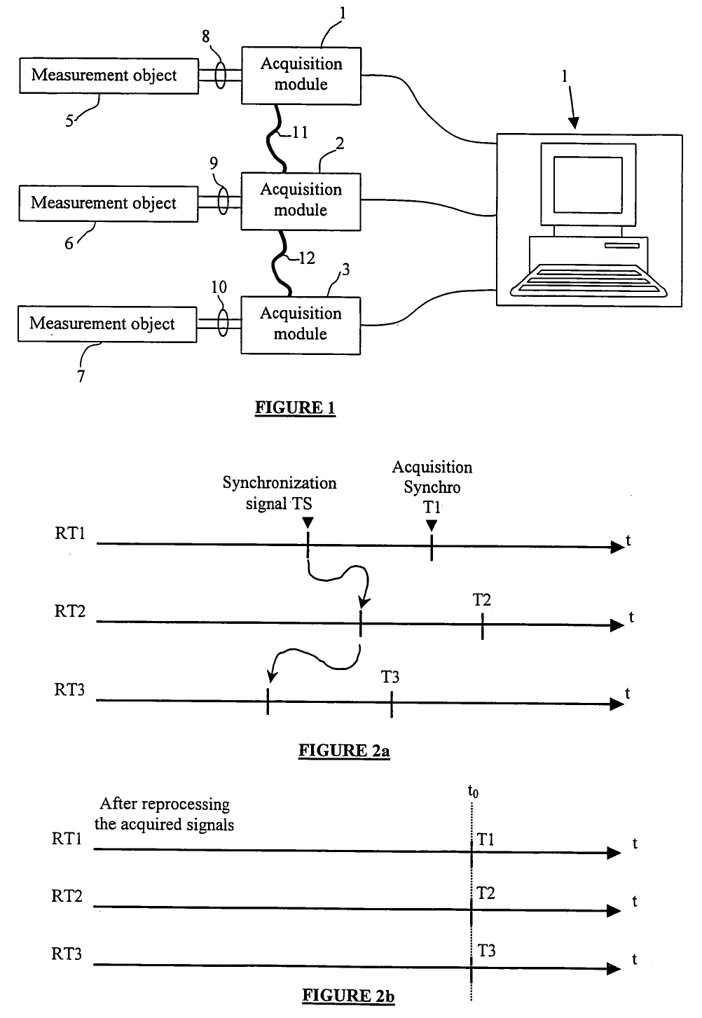

FIG. 1 is a diagram illustrating a multi-channel acquisition system according to the invention, and

FIGS. 2a and 2b are graphs illustrating the time references of the different acquisition modules according to a particular example of embodiment.

FIG. 1 shows a multi-channel acquisition system according to the invention. Three acquisition modules 1, 2, 3 can be seen, each one being connected to a microcomputer 4. It is also possible to envisage an acquisition system without a microcomputer in which each acquisition module is autonomous and is connected to a communication network of the internet type.

The acquisition modules 1, 2, 3 are respectively connected to measurement objects 5, 6, 7 by means of the connectors 8, 9, 10. The measurement objects 5, 6, 7 can for example be temperature sensors or even pressure sensors. These objects can be a platinum probe, a thermocouple, a pressure transducer, a strain gauge, etc, arranged in different places of a machine for which it is desired to know the behaviour as a function of stimuli, i.e. the reaction of different parts of the machine in response to a given action. For this type of experimentation making use of several acquisition channels, it is important to synchronize all of the signals received by the microcomputer 4. It will thus be possible for example to detect propagation phenomena in the machine.

The present invention proposes a solution in which one of the acquisition modules, for example acquisition module 1, transmits its synchronization signal to the other acquisition modules 2 and 3 at a given time. This synchronization signal is equivalent to a time T₀, which can correspond to a time at which the acquisition modules 1, 2, 3 are authorized to instantly transmit the acquired signals to the microcomputer 4.

The signals passing between the measurement objects 5, 6, 7 and the acquisition modules 1, 2, 3 are of the analog type. In order for the synchronization signal symbolizing the time origin T₀ to be the same for all of the acquisition modules, the time of propagation of that synchronization signal between the transmitting acquisition module and the receiving acquisition modules must be negligible with respect to the speed of variation of the acquired analog signals.

The present invention makes provision for transmitting the synchronization signal optically. This transmission can be carried out directly by the mechanical construction of the acquisition modules, i.e. the arrangement of the acquisition modules 1, 2, 3 can be done in such a way that an optical transmitter arranged in the acquisition module 1 is capable of transmitting an optical signal that can be detected by an optical sensor arranged in the acquisition module 2. This arrangement can be achieved by placing the acquisition modules 1, 2, 3 sufficiently close to each other. Similarly, an optical transmitter arranged in the acquisition module 2 can be directly facing an optical receiver arranged in the acquisition module 3.

When each acquisition module is capable of transmitting the synchronization signal, it then comprises an optical transmitter and an optical receiver on each side.

Preferably, in order to avoid restrictive arrangements, the synchronization signal can be transmitted via optical fibres 11 and 12. Each end of an optical fibre is placed facing an optical transmitter and an optical receiver. It is possible to use the same optical fibre for transmitting or for receiving the synchronization signal.

The synchronization signal is preferably transmitted in response to an instruction. This instruction can be the fact that an analog signal passing through the connectors 8, 9 or 10 exceeds a predetermined threshold. The instruction can also come from a control button arranged on an acquisition module, this control button being able to be actuated by a user. The instruction can also come from the microcomputer 4 which transmits a piece of information to the acquisition module 1, the latter then having the task of transmitting the synchronization signals to the acquisition modules 2 and 3.

In the arrangement shown in FIG. 1, the acquisition module 2 has the task of detecting a synchronization signal and of retransmitting it when that synchronization signal comes from the acquisition module 1 or 3.

FIG. 2a is a graph upon which three time references RT1, RT2 and RT3 of the three acquisition modules 1, 2 and 3 can be seen. In this system of FIG. 2a according to the invention, each acquisition module comprises internal dating. On the time reference RT1, TS denotes the event triggering the synchronization signal. According to the invention, it is possible to specify whether the acquired signals are taken into account a certain time before or after the synchronization signal. In the example shown in FIG. 2a, the case of a pre-synchronization is described in which the synchronization is effective starting from T1 in the acquisition module 1, T2 in the acquisition module 2 and T3 in the acquisition module 3. In fact, T1, T2 and T3 correspond to a same absolute time, but referenced by different times in each internal dating system. For example, T1 can correspond to 123.32 milliseconds in the time reference system RT1; T2 can correspond to 112.25 milliseconds in the time reference system RT2 and T3 can correspond to 130.30 milliseconds in the time reference system RT3. It is in the processing unit 1 that the signals are repositioned in order to make the times T1, T2 and T3 correspond as shown in FIG. 2b. The processing unit 1 can then process the acquired signals on the basis of T1=T2=T3.

The invention is not of course limited to the examples that have just been described and numerous modifications can be applied to these examples without exceeding the scope of the invention: in particular a method of transmission of the synchronization signal by radio waves can be envisaged. In this case, each acquisition module comprises a transmitting and receiving antenna. It is also possible to envisage a method of transmission by magnetic coupling.

1. Multi-channel acquisition system for measuring physical parameters, comprising a plurality of acquisition modules each constituting at least one acquisition channel, characterized in that each acquisition module comprises an internal dating system and in that at least one of the acquisition modules comprises synchronization means for transmitting a synchronization signal equivalent to a time t₀ to at least one other acquisition module in response to a synchronization instruction, this synchronization signal making it possible to define in each acquisition module a specific t₀ referenced in the internal dating system of each acquisition module.

2. Acquisition system according to claim 1, characterized in that the synchronization means comprise means for transmitting an optical synchronization signal.

3. Acquisition system according to claim 2, characterized in that the acquisition modules are interconnected by means of optical fibres.

4. Acquisition system according to claim 1, characterized in that the synchronization means comprise means for transmitting a synchronization signal by magnetic coupling.

5. Acquisition system according to claim 1, characterized in that the synchronization means comprise means for transmitting a synchronization signal by radio waves.

6. Acquisition system according to claim 1, characterized in that the synchronization instruction comes from an electrical signal acquired on a measurement object.

7. Acquisition system according to claim 1, characterized in that the synchronization instruction comes from a processing unit connected to the acquisition module transmitting the synchronization signal.

8. Acquisition system according to any one of the preceding claims claim 1, characterized in that the acquisition modules are physically interconnected in a star configuration.

9. System according to claim 1, characterized in that the acquisition modules are physically interconnected in series.

10. Acquisition module for measuring physical parameters, characterized in that it comprises an internal dating system and in that it comprises synchronization means for transmitting a synchronization signal equivalent to a time t₀ to at least one other acquisition module in response to a synchronization instruction, this synchronization signal making it possible to define in each acquisition module a specific t₀ referenced in the internal dating system of each acquisition module.

11. Acquisition module according to claim 10, characterized in that it furthermore comprises means for receiving a synchronization signal coming from at least one other acquisition module.

12. Acquisition method for measuring physical parameters, implemented in a system according to claim 1, characterized in that, with each acquisition module comprising an internal dating system, when an acquisition module receives an instruction, that acquisition module transmits a synchronization signal equivalent to a time t₀ to the other acquisition modules and in that this synchronization signal is associated with a time referenced in the internal dating system of each acquisition module.

13. Acquisition system according to claim 2, characterized in that the synchronization instruction comes from an electrical signal acquired on a measurement object.

14. Acquisition system according to claim 3, characterized in that the synchronization instruction comes from an electrical signal acquired on a measurement object.

15. Acquisition system according to claim 4, characterized in that the synchronization instruction comes from an electrical signal acquired on a measurement object.

16. Acquisition system according to claim 5, characterized in that the synchronization instruction comes from an electrical signal acquired on a measurement object.

17. Acquisition system according to claim 2, characterized in that the synchronization instruction comes from a processing unit connected to the acquisition module transmitting the synchronization signal.

18. Acquisition system according to claim 3, characterized in that the synchronization instruction comes from a processing unit connected to the acquisition module transmitting the synchronization signal.

19. Acquisition system according to claim 4, characterized in that the synchronization instruction comes from a processing unit connected to the acquisition module transmitting the synchronization signal.

20. Acquisition system according to claim 5, characterized in that the synchronization instruction comes from a processing unit connected to the acquisition module transmitting the synchronization signal.
